(19) United States
(12) Patent Application Publication
(10) Pub. No.: US 2005/0049997 A1
(43) Pub. Date: Mar. 3, 2005

(54) Method for persisting a unicode compatible offline address

(75) Inventor: Neil Leonard Shipp, Bellevue, WA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Microsoft Corporation, Redmond, WA (US)

(21) Appl. No.: 10/649,135

(22) Filed: Aug. 27, 2003

(51) Int. Cl. G06F 7/00

(52) U.S. Cl. 707/1

(57) ABSTRACT

Disclosed is a method for persisting an offline address book in a Unicode compatible format without changing the underlying file formats, record representations, and low level string comparisons. By storing the text information in UCS Transformation Format-8 (UTF-8), Unicode strings can be represented in 8-bit widths and thus are interpreted as just another multi byte character representation. Additionally the offline address book files can still be efficiently searched using the same algorithms for text searching as long as the search key is converted to UTF-8 first.

### TECHNICAL FIELD

The present invention relates generally to e-mail systems and, more particularly, to methods of persisting an offline address book.

### BACKGROUND OF THE INVENTION

E-mail systems are ubiquitous in the landscape of today's corporate information infrastructures. Increasingly there has been a need for offline access and functionality of such e-mail systems. When an e-mail client account is configured to use offline access, it typically works from a local copy of a user's mailbox stored on the user's computer, along with an offline address book. The cached mailbox and offline address book are usually updated periodically from the e-mail server.

When an e-mail system is configured for offline access, the user may enjoy a better online and offline messaging experience because a copy of the user's mailbox is stored on the local computer. The primary benefits of using offline access are 1.) shielding the user from troublesome network and server connection issues; and 2.) facilitating switching back and forth from online to offline for mobile users. By caching the user's mailbox and the offline address book locally, the e-mail client no longer depends on on-going network connectivity for access to user information. In addition, users' mailboxes are kept up to date, so if a user disconnects from the network—for example, by removing a laptop from a docking station—the latest information is automatically available offline.

One drawback to offline access however has been the offline address book. For example with Microsoft Exchange, a popular commercial e-mail server, and Microsoft Outlook, a popular commercial e-mail client, the offline address book information is not stored on the client with 100% fidelity since the offline address book server renders the Unicode data into a predetermined code page that may not have mappings for the original Unicode characters. This is due to the fact that the offline address book was designed when most offline users used lightweight DOS and 16-bit Windows clients that did not support Unicode. The end result is that characters not defined for the server's code page are rendered as question marks and the offline clients have to make do with reduced information.

With the increasing prevalence of Unicode character sets it has become critical that offline address books have the ability accommodate such character sets. Unfortunately though, such a modification to the offline address book would result in a sizeable impact on the underlying file structure to accommodate the increased 16-bit width of Unicode characters. Additionally, converting the offline address book to Unicode would also necessitate corresponding changes in the methods to browse the offline address book as the current methods employing low level string comparisons would no longer be operational.

### SUMMARY OF THE INVENTION

In view of the foregoing, the present invention provides a method for persisting an offline address book in a Unicode compatible format without changing the underlying file formats, record representations, and low level string comparisons. By storing the text information in UCS Transformation Format-8 (UTF-8), Unicode strings can be represented in 8-bit widths and thus are interpreted as just another multi byte character representation. Additionally the offline address book files can still be efficiently searched using the same algorithms for text searching as long as the search key is converted to UTF-8 first.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a schematic diagram of an exemplary computer architecture on which the method of the invention can be implemented;

FIG. 2 is a schematic diagram showing an exemplary communications network in which the method of the invention can be practiced;

FIG. 3 is a schematic diagram showing an exemplary e-mail system architecture;

FIG. 4 is a schematic diagram showing an exemplary offline e-mail system architecture;

FIG. 5 is a flowchart illustrating the method of displaying a UTF-8 encoded string; and

FIG. 6 is a flowchart illustrating methods of searching the offline address book.

### DETAILED DESCRIPTION OF THE INVENTION

In the description that follows, the invention is described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains them at locations in the memory system of the computer, which reconfigures or otherwise alters the operation of the computer in a manner well understood by those skilled in the art. The data structures where data are maintained are physical locations of the memory that have particular properties defined by the format of the data. However, while the invention is being described in the foregoing context, it is not meant to be limiting as those of skill in the art will appreciate that several of the acts and operations described hereinafter may also be implemented in hardware.

Turning to the drawings, wherein like reference numerals refer to like elements, the invention is illustrated as being implemented in a suitable computing environment. The following description is based on illustrated embodiments of the invention and should not be taken as limiting the invention with regard to alternative embodiments that are not explicitly described herein.

### I. Exemplary Environment

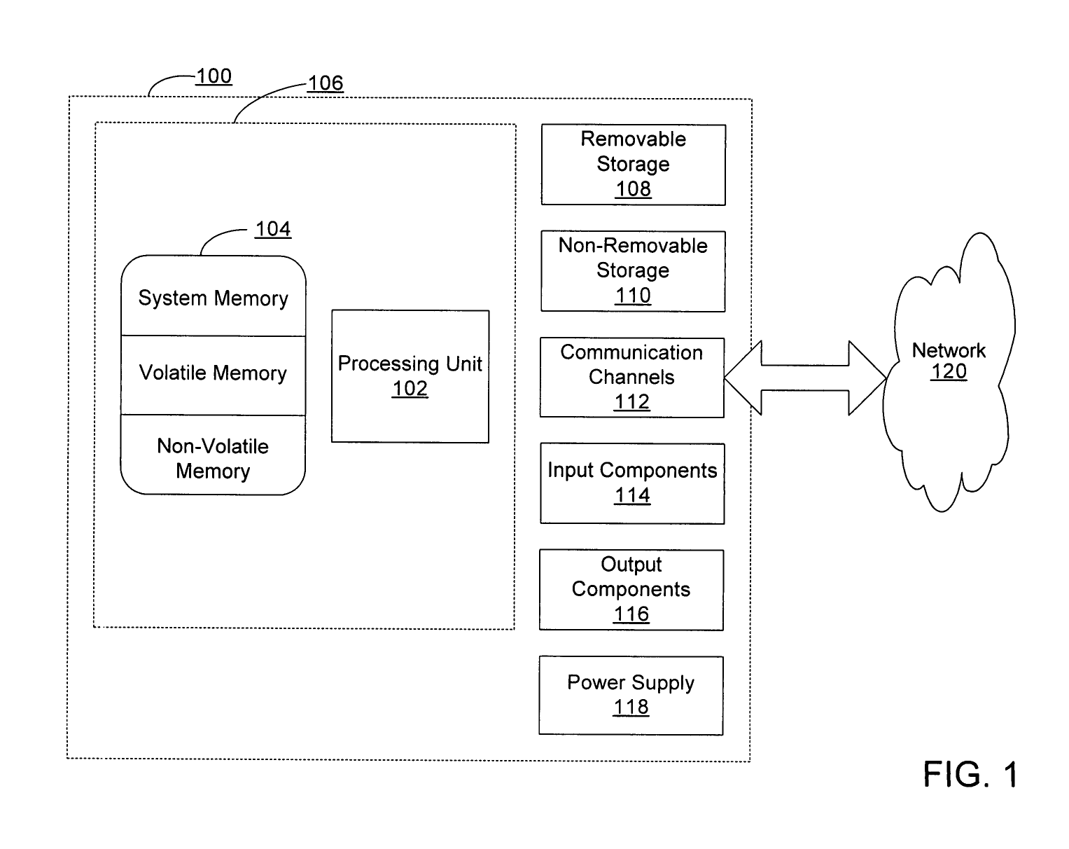

Referring to FIG. 1, the present invention relates to communications between network nodes on connected computer networks. Each of the network nodes resides in a computer that may have one of many different computer architectures. For descriptive purposes, FIG. 1 shows a schematic diagram of an exemplary computer architecture usable for these devices. The architecture portrayed is only one example of a suitable environment and is not intended to suggest any limitation as to the scope of use or functionality of the invention. Neither should the computing devices be interpreted as having any dependency or requirement relating to any one or combination of components illustrated in FIG. 1. The invention is operational with numerous other general-purpose or special-purpose computing or communications environments or configurations. Examples of well known computing systems, environments, and configurations suitable for use with the invention include, but are not limited to, mobile telephones, pocket computers, personal computers, servers, multiprocessor systems, microprocessor-based systems, minicomputers, mainframe computers, and distributed computing environments that include any of the above systems or devices.

In its most basic configuration, a computing device 100 typically includes at least one processing unit 102 and memory 104. The memory 104 may be volatile (such as RAM), non-volatile (such as ROM and flash memory), or some combination of the two. This most basic configuration is illustrated in FIG. 1 by the dashed line 106.

Computing device 100 can also contain storage media devices 108 and 110 that may have additional features and functionality. For example, they may include additional storage (removable and non-removable) including, but not limited to, PCMCIA cards, magnetic and optical disks, and magnetic tape. Such additional storage is illustrated in FIG. 1 by removable storage 108 and non-removable storage 110. Computer-storage media include volatile and non-volatile, removable and non-removable media implemented in any method or technology for storage of information such as computer-readable instructions, data structures, program modules, or other data. Memory 104, removable storage 108, and non-removable storage 110 are all examples of computer-storage media. Computer-storage media include, but are not limited to, RAM, ROM, EEPROM, flash memory, other memory technology, CD-ROM, digital versatile disks, other optical storage, magnetic cassettes, magnetic tape, magnetic disk storage, other magnetic storage devices, and any other media that can be used to store the desired information and that can be accessed by the computing device.

Computing device 100 can also contain communication channels 112 that allow it to communicate with other devices. Communication channels 112 are examples of communications media. Communications media typically embody computer-readable instructions, data structures, program modules, or other data in a modulated data signal such as a carrier wave or other transport mechanism and include any information-delivery media. The term “modulated data signal” means a signal that has one or more of its characteristics set or changed in such a manner as to encode information in the signal. By way of example, and not limitation, communications media include wired media, such as wired networks and direct-wired communications, and wireless media such as acoustic, radio, infrared, and other wireless media. The term computer-readable media as used herein includes both storage media and communications media. The computing device 100 may also have input components 114 such as a keyboard, mouse, pen, a voice-input component, and a touch-input device. Output components 116 include screen displays, speakers, printers, and rendering modules (often called “adapters”) for driving them. The computing device 100 has a power supply 118. All these components are well known in the art and need not be discussed at length here.

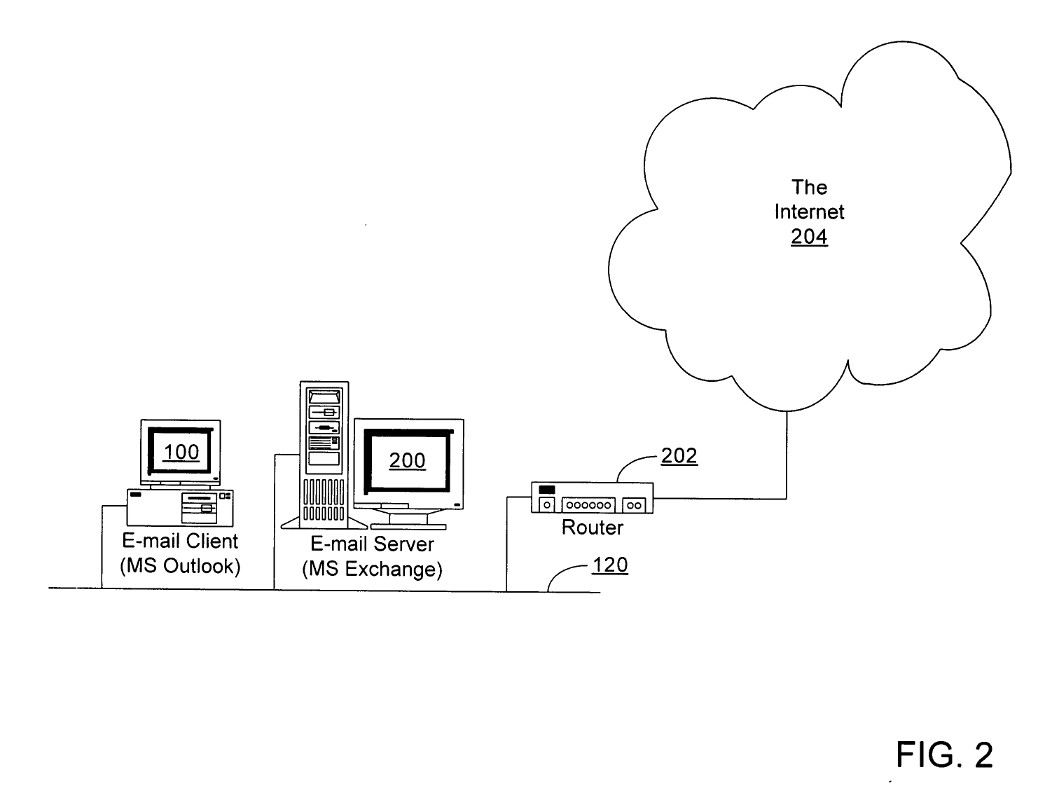

Turning to FIG. 2, accompanying a computing device 100 on a local area network (LAN) 120 is a server 200 and a router 202. The router allows the devices on the LAN to communicate over an internetwork 204 to remote computing devices. The Internet is one example of an internetwork. In the case of the present invention, the server 200 is an e-mail server running Microsoft Exchange or another e-mail server software package and the computing device 100 is an e-mail client running Microsoft Outlook or another e-mail client.

### II. Offline Messaging and the Offline Address Book

The present invention is directed to a method for persisting an offline address book in a Unicode compatible format.

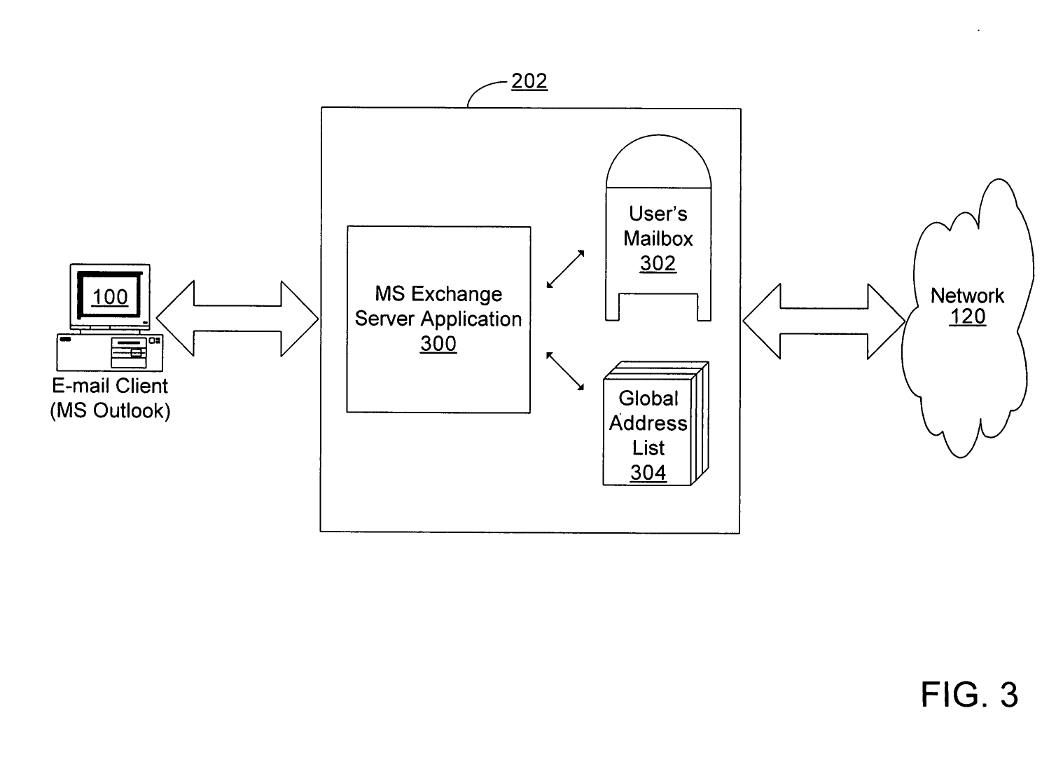

Referring to FIG. 3, an exemplary e-mail system architecture is represented. A user wishing to send e-mail would open the e-mail client program on the computing device 100. Upon starting, the e-mail client establishes a connection with the e-mail server 202 via the e-mail server application 300. The user can then initiate the creation of an e-mail message by addressing the message to the proper recipient by either selecting the appropriate entry from the global address list 304 or, in the alternative, by entering the recipient's address which the client will then attempt to resolve via the global address list 304. All incoming and outgoing messages are stored in the user's mailbox 302 located on the server 202.

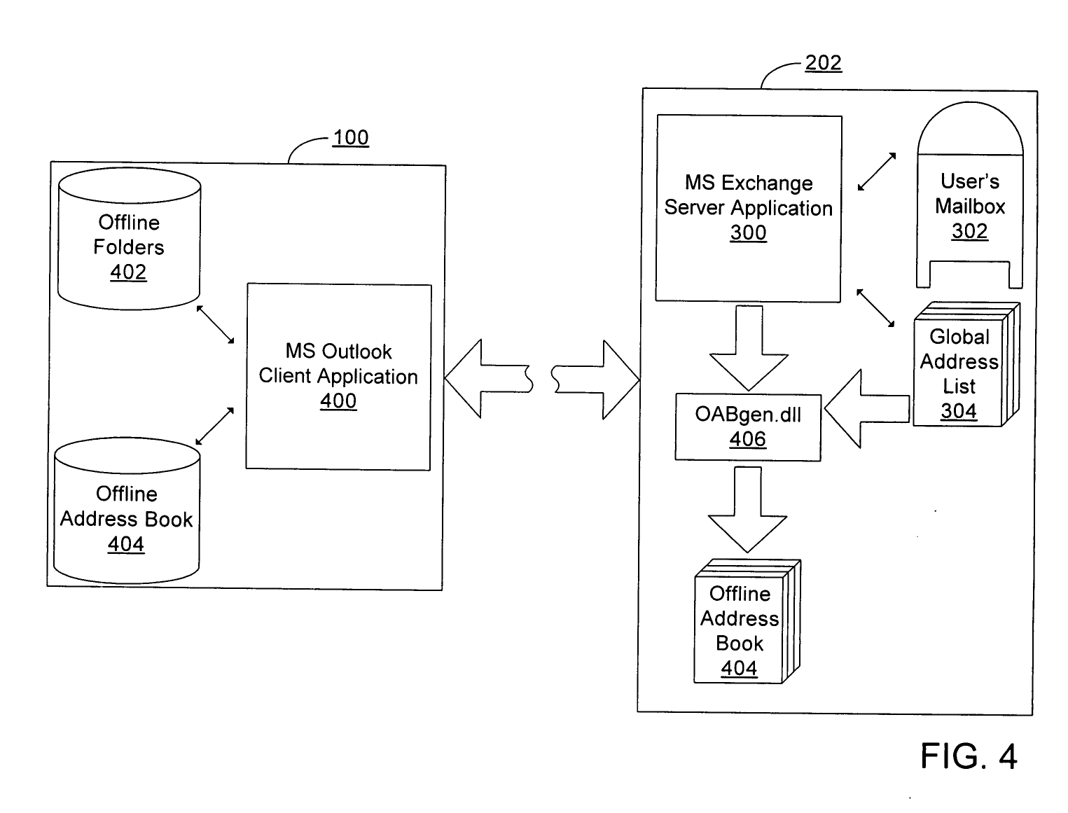

Turning to FIG. 4, an exemplary offline e-mail system architecture is depicted. When an e-mail client 100 is configured to use offline access, the e-mail client application 400 works from a local copy of a user's mailbox 302 stored in an offline folders file 402 on the user's computer 100, along with the offline address book 404. The cached mailbox 402 and offline address book 404 can be updated periodically from the e-mail server 202. When a user starts the e-mail client application 400 for the first time with offline access configured, the e-mail client application 400 creates a local copy of the user's mailbox 302 by creating an offline folders file 402 (unless one already exists), synchronizing the offline folders 402 with the user's mailbox 302 on the e-mail server 202, and creating an offline address book 404. If a user is already configured for offline use with offline folders 402 and an offline address book 404, the e-mail client application 400 can typically download just the new information from the server 202, not the whole mailbox and offline address book.

In one embodiment the offline address book 404 is generated on a schedule set by the Microsoft Exchange administrator. The Exchange system attendant process calls OABgen.dll 406 at the appropriate time to regenerate the offline address book 404. OABgen.dll 406 creates a new offline address book 404 message each time it runs (usually once per day). In this embodiment the offline address book 404 is a special message in a public folder which contains 5 attachments. The attachments consist of 5 parts: 1.) the browse file; 2.) the ambiguous name resolution (ANR) file; 3.) the relative distinguished name (RDN) file; 4.) the details file; and 5.) the templates files. There is one template file for each language supported by the server. These parts of the offline address book are compressed by the server and stored in the compressed format as attachments.

The browse file (browse.oab) is a file of fixed length records that map 1:1 to each entry in the address book and is laid out in the alphabetical sort order that the directory service returns them to clients. There is no textual information in this file, but it has offset pointers into the ANR, RDN, and details files for the RDN, details info, Simple Mail Transfer Protocol (SMTP) address, display name, account name, office location, and surname.

The ANR file (anrdex.oab) is composed of variable length records, containing information such as display name, surname, account name, and office location, that form a binary tree structure. Each record has a text string associated with it that is stored as in a multi byte character set (MBCS) encoding, and integer offsets that point to other records within the same file and back to the browse file. The tree structure allows the file to be searched efficiently.

The RDN file (rdndex.oab) is composed of variable length records, containing the primary SMTP address and legacy Exchange distinguished names of the users, that form a threaded binary tree structure. The RDN file contains information to generate the entry id of the user's record (i.e., the long term entry id, or LTEID). Each record has a text string associated with it that is stored as in a multi byte character set (MBCS) encoding, and integer offsets that point to other records within the same file and back to the browse file. The tree structure allows the file to be searched efficiently. At the beginning of the RDN file is a table of parent distinguished name (PDNs). PDNs are the first part of a distinguished name address. The PDN plus the RDN are used to create the full legacy Exchange distinguished name.

The details file (details.oab) is composed of variable length records that encode non-searchable data for each entry in the browse file (e.g., locality, street address, phone number, user certificates etc.). This data is composed of binary, integer, boolean, and MBCS text information. The list of records in it is hard-coded (i.e., not configurable by the Exchange admin).

The template file (tmplts.oab) consists of variable length records that encode rules for how to graphically display information about entries on the client computer (i.e., the Messaging Application Programming Interface (MAPI) template for displaying records). There is one template per language and multiple languages, although the client will only download one template.

In addition to the offline address book message, OABgen.dll generates a “diff” (also called “changes”) file, which contains the incremental changes between the new offline address book message and the previous offline address book message. Differential offline address book messages are generated each time the offline address book generation runs. The server constructs the current offline address book, downloads the old offline address book, and generates a difference file. It publishes this in a separate message in the same folder as the regular offline address book message. The server also sets the PR_OVERALL_AGE_LIMIT property on the offline address book folder to 30 days. This is done so that old differential messages will be expired and deleted automatically by the public folder store.

The first time a Microsoft Outlook client downloads the offline address book, it downloads the anrdex.oab, browse.oab, rdndex.oab, and tmplts.oab offline address book attachments. If the client is set to download offline address book details, it will also download the details.oab file. After downloading the full offline address book, the client splits the PDN table out of the RDN file into the PDN file (pdndex.oab). The client downloads each of the attachments to the offline address book file separately, and decompresses them locally. The client stores them as separate files. This means compressed files are on the public folder server attached to a special message in the default OAB folder. Uncompressed files are on the client, in the Outlook folder. The anrdex.oab, browse.oab, details.oab, pdndex.oab, rdndex.oab, and tmplts.oab files are located in the directory “C:\Documents and Settings<username>\Local Settings\Application Data\Microsoft\Outlook.

Each file starts with the offline address book version, the serial number (a checksum hash of the RDN), and the total number of records in the offline address book file. This count of the total number of records in the offline address book is only reliable after a full download of the ANR, RDN, details and template files, or after a successful differential update from a diff file (see below). The count in the browse file reflects the total number of records in the offline address book.

If the client already has downloaded an offline address book, and only needs to get updates, it downloads “diff” files. If a user has not synced for N days, they will sync N diff files, where the system administrator has scheduled the offline address book to be generated once a day. If the Ndiff files have a size which is greater than 1/8th the size of the offline address book message, then the client elects to do a full download instead of incremental changes.

When an incremental change file is downloaded, it is unpacked and the data is transferred to the existing client files on disk. Records in the offline address book files are inter-linked, and these links are maintained as data is added and deleted. Maintaining the links when processing the change file is very client-cpu and disk intensive. The client makes a copy of the browse file, walking the diff file and copying the old file in with the changes to the new copy.

The diff structure is a variable length record that contains an iBrowse, dwType, dwFlags (i.e., specifying the type of change: delete, modify, insert), and finally the new or modified record info. The diff file contains details information. Thus, there is no real advantage to having a “no details” offline address book for incremental downloads. Of course, a full download of the offline address book can be smaller if the client has selected “no details” in Microsoft Outlook. The default to download full details is also set by policy, although it can be overridden on the client.

A full-download of the offline address book would also occur when there is a new legacy Exchange distinguished name added to the forest, or an old one changes. The full download is required because the new prefix changes the lookup table at the start of the RDN file.

### III. UCS Transformation Format-8 (UTF-8)

The international standard ISO 10646 defines the Universal Character Set (UCS). UCS is a superset of all other character set standards. It guarantees round-trip compatibility to other character sets. If any text string is converted to UCS and then back to the original encoding, then no information will be lost. UCS contains the characters required to represent practically all known languages.

The Unicode Standard published by the Unicode Consortium corresponds to ISO 10646. All characters are at the same positions and have the same names in both standards. However, the Unicode Standard defines much more semantics associated with some of the characters and is in general a better reference for implementors of high-quality typographic publishing systems. Unicode specifies algorithms for rendering presentation forms of some scripts (e.g., Arabic), handling of bi-directional texts that mix for instance Latin and Hebrew, algorithms for sorting and string comparison, and much more.

UCS and Unicode are first of all just code tables that assign integer numbers to characters. There exist several alternatives for how a sequence of such characters or their respective integer values can be represented as a sequence of bytes. The two most obvious encodings store Unicode text as sequences of either 2 or 4 bytes sequences. The official terms for these encodings are UCS-2 and UCS-4 respectively. Unless otherwise specified, the most significant byte comes first in these (Bigendian convention). An ASCII or Latin-1 file can be transformed into a UCS-2 file by simply inserting a 0x00 byte in front of every ASCII byte. If it is desired to have a UCS-4 file, three 0x00 bytes will have to be inserted instead before every ASCII byte.

Using UCS-2 (or UCS-4) can lead to very severe problems. Strings with these encodings can contain as parts of many wide characters bytes like ‘\0’ or ‘/’ which have a special meaning in filenames and other C library function parameters. In addition, the majority of software tools expects ASCII files and cannot read 16-bit words as characters without major modifications. For these reasons, UCS-2 is not a suitable external encoding of Unicode in filenames, text files, environment variables, etc.

UCS Transformation Format-8 (UTF-8) encodes Unicode characters with a variable number of bytes per character. This encoding is optimized for the lower 127 ASCII characters, yielding an efficient mechanism to encode English in an international scheme. The UTF-8 identifier is the Unicode byte order mark, hexadecimal 0xFEFF, which is represented in UTF-8 as hexadecimal 0xEF 0xBB 0xBF. The byte order mark is used to distinguish UTF-8 text from other encodings.

UTF-8 has the following properties:
UCS characters U+0000 to U+007F (ASCII) are encoded simply as bytes 0x00 to 0x7F (ASCII compatibility). This means that files and strings which contain only 7-bit ASCII characters have the same encoding under both ASCII and UTF-8.
All UCS characters>U+007F are encoded as a sequence of several bytes, each of which has the most significant bit set. Therefore, no ASCII byte (0x00-0x7F) can appear as part of any other character.
The first byte of a multibyte sequence that represents a non-ASCII character is always in the range 0xC0 to 0×FD and it indicates how many bytes follow for this character. All further bytes in a multibyte sequence are in the range 0x80 to 0xBF. This allows easy resynchronization and makes the encoding stateless and robust against missing bytes.
All possible 231 UCS codes can be encoded.
UTF-8 encoded characters may theoretically be up to six bytes long, however 16-bit basic multilingual plane (BMP) characters are only up to three bytes long.
The sorting order of Bigendian UCS-4 byte strings is preserved.
The bytes 0xFE and 0xFF are never used in the UTF-8 encoding.

The following byte sequences are used to represent a character. The sequence to be used depends on the Unicode number of the character:

| | | | | | | |
|---|---|---|---|---|---|---|
| U-00000000-U-0000007F: | 0xxxxxxx | | | | | |
| U-00000080 - U-000007FF: | 110xxxxx | 10xxxxxx | | | | |
| U-00000800 - U-0000FFFF: | 1110xxxx | 10xxxxxx | 10xxxxxx | | | |
| U-00010000 - U-001FFFFF: | 11110xxx | 10xxxxxx | 10xxxxxx | 10xxxxxx | | |
| U-00200000 - U-03FFFFFF: | 111110xx | 10xxxxxx | 10xxxxxx | 10xxxxxx | 10xxxxxx | |
| U-04000000 - U-7FFFFFFF: | 1111110x | 10xxxxxx | 10xxxxxx | 10xxxxxx | 10xxxxxx | 10xxxxxx |

The xxx bit positions are filled with the bits of the character code number in binary representation. The rightmost x bit is the least-significant bit. Only the shortest possible multibyte sequence which can represent the code number of the character can be used. Note that in multibyte sequences, the number of leading 1 bits in the first byte is identical to the number of bytes in the entire sequence. For further information see Kuhn, Markus, “UTF-8 and Unicode FAQ for Unix/Linux”, http://www.cl.cam.ac.uk/˜mgk25/unicode.html, which is herein incorporated in its entirety for everything it describes.

### IV. Method of Persisting a Unicode Compatible Offline Address Book

In Microsoft Exchange each offline address book is currently generated by a single server in the default system codepage, so characters that cannot be converted to the code page of the Exchange server become question marks. This can result in loss of information that is out of the hands of the user. By generating the offline address book in Unicode, the client can preserve the Unicode data and is able to render Unicode in the Microsoft Outlook e-mail client user interface. This way regardless of the code page of the client, no information is lost.

The method of the present invention provides for persisting an offline address book in a Unicode compatible format without changing the underlying file formats, record representations, and low level string comparisons. By storing the text information in UTF-8, Unicode strings can be represented in 8-bit widths and thus are interpreted as just another multi byte character representation. Additionally the offline address book files can still be efficiently searched using the same algorithms for text searching as long as the search key is converted to UTF-8 first.

In one embodiment all text strings not related to templates are converted to UTF-8 strings. This includes all entries in the details file, the ANRdex file, and the RDNdex file. Even though the strings will be stored in UTF-8, the non mbcs-aware function _stricmp( ) will continue to be used for sorting the list and traversing the RDN index tree. The ANR index tree can be sorted using CompareString( ) with the current sort locale.

As will be appreciated by one of ordinary skill in the art, the encoding of a string can be achieved by using, for example, a Visual Basic, C#, or C++ method call such as GetBytes(unicodeString) and the decoding can be similarly achieved by an analagous method call such as GetString(encodedBytes).

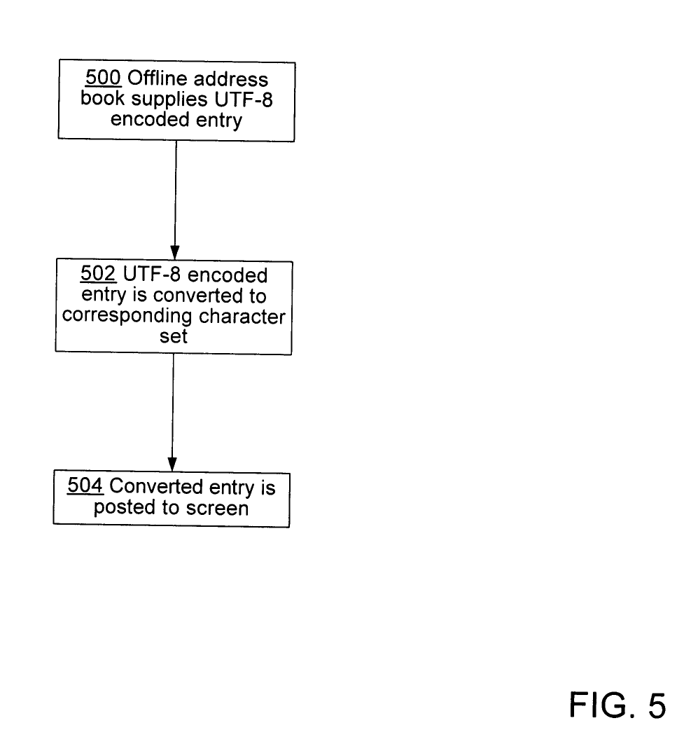

Turning to FIG. 5, a method of displaying a UTF-8 encoded offline address book entry is illustrated. In step 500 the offline address book supplies a UTF-8 encoded entry. Next, in step 502 the supplied entry is decoded. Finally in step 504 the decoded entry is posted to the screen where the user can see the decoded string.

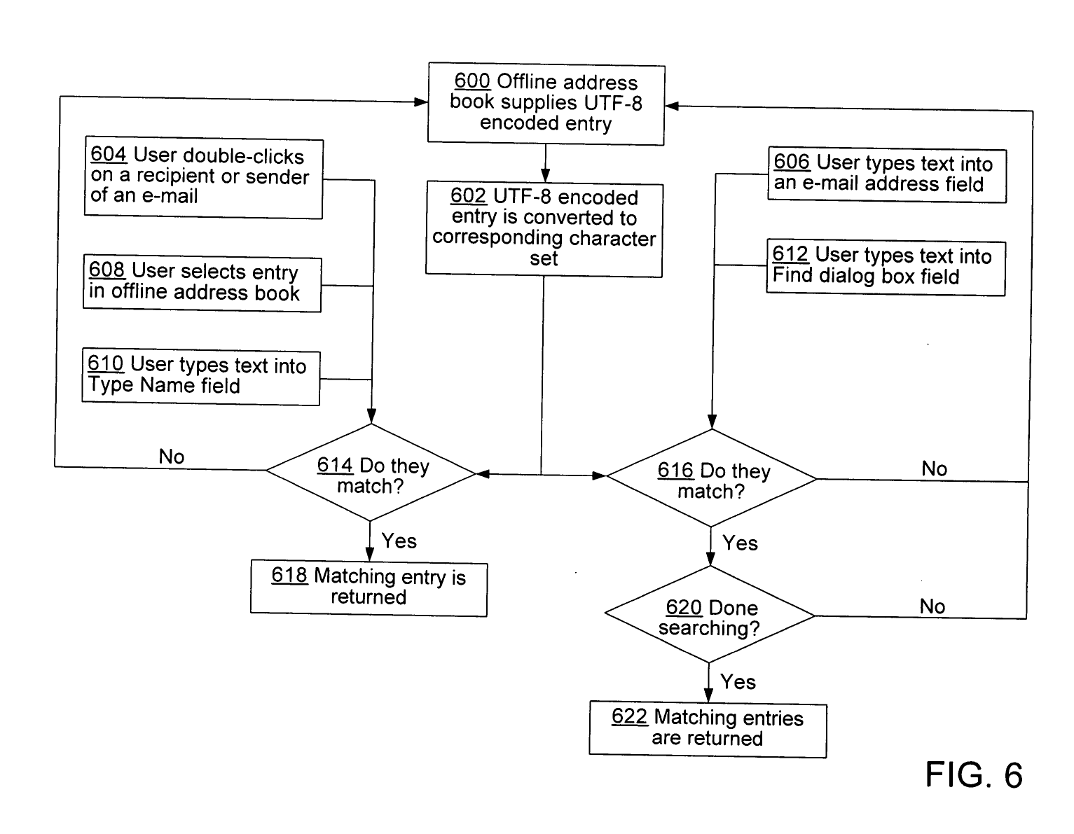

In FIG. 6 methods for searching a UTF-8 encoded offline address book are illustrated. In Microsoft Outlook, for example, searches can be effectuated in two different manners; one being for a specific offline address book entry and the other being a search for a potential plurality of records matching the search criteria. Steps 604, 608, and 610 illustrate the first type of search in that a user provides offline address book search input by double-clicking a particular recipient or sender on a mail message 604, by scrolling through the offline address book list of entries and selecting a particular entry for retrieval 608, or by using type-down (i.e., typing in the first few letters in the Type Name field and the list box scrolls down to the entry that start with those letters) 610. In each of these scenarios the search input provided by the user is compared in step 614 to a UTF-8 encoded offline address book entry 600 which has been decoded in step 602. If there is a match then the process proceeds to step 618 and the matching entry is returned, otherwise the comparison step of 614 is repeated with another offline address book entry.

A similar process is illustrated in the other type of search in steps 606 and 612. In these searches the user provides offline address book search input by typing in an e-mail address, user name or some other ANR field as an address on an e-mail message and either selecting send or check names 606 or by using the Find dialog to search for entries on any field populated in the ANR or RDN files such as display name, surname, office, smtp address, or account name 612. In each of these scenarios the search input provided by the user is compared in step 616 to a UTF-8 encoded offline address book entry 600 which has been decoded in step 602. If there is a match then the process proceeds to step 620 where it is determined whether the all the entries have been searched. This search can then terminate in step 622 by returning a unique address book entry if an exact match is found, a selection of entries if an ambiguous match occurs, or no entries if there are no suitable matches.

In view of the many possible embodiments to which the principles of this invention may be applied, it should be recognized that the embodiments described herein with respect to the drawing figures are meant to be illustrative only and should not be taken as limiting the scope of invention. For example, for performance reasons the method of the present invention may be implemented in hardware, rather than in software. Therefore, the invention as described herein contemplates all such embodiments as may come within the scope of the following claims and equivalents thereof.

1. A method for persisting an offline address book, the method comprising representing textual information in a format, wherein the format allows for representation of greater than 256 characters using 8-bit character widths.

2. The method of claim 1 wherein the offline address book's underlying file format remains unaltered.

3. The method of claim 1 wherein the offline address book's underlying representation remains unaltered.

4. The method of claim 1 wherein low level string comparisons with the offline address book are able to be performed.

5. The method of claim 1 wherein the format is UTF-8.

6. The method of claim 1 wherein the offline address book is MAPI compliant.

7. A computer-readable medium containing instructions for performing a method for persisting an offline address book, the method comprising representing textual information in a format, wherein the format allows for representation of greater than 256 characters using 8-bit character widths.

8. A method for displaying an offline address book, the method comprising:
accepting textual information from the offline address book in a format, wherein the format allows for representation of greater than 256 characters using 8-bit character widths;
converting the textual information to a corresponding character set; and
posting the converted textual information to an output mechanism.

9. The method of claim 8 wherein the offline address book's underlying file format remains unaltered.

10. The method of claim 8 wherein the offline address book's underlying representation remains unaltered.

11. The method of claim 8 wherein low level string comparisons with the offline address book are able to be performed.

12. The method of claim 8 wherein the format is UTF-8.

13. The method of claim 8 wherein the offline address book is MAPI compliant.

14. A computer-readable medium containing instructions for performing a method for displaying an offline address book, the method comprising:
accepting textual information from the offline address book in a format, wherein the format allows for representation of greater than 256 characters using 8-bit character widths;
converting the textual information to a corresponding character set; and
posting the converted textual information to an output mechanism.

15. A method for searching an offline address book, the method comprising:
accepting a first textual information from the offline address book in a format, wherein the format allows for representation of greater than 256 characters using 8-bit character widths;
accepting a second textual information in a native character set representation;
converting the first textual information to a corresponding character set; and
comparing the converted first textual information to the second textual information.

16. The method of claim 15 wherein the offline address book's underlying file format remains unaltered.

17. The method of claim 15 wherein the offline address book's underlying representation remains unaltered.

18. The method of claim 15 wherein low level string comparisons with the offline address book are able to be performed.

19. The method of claim 15 wherein the format is UTF-8.

20. The method of claim 15 wherein the offline address book is MAPI compliant.

21. A computer-readable medium containing instructions for performing a method for searching an offline address book, the method comprising:
accepting a first textual information from the offline address book in a format, wherein the format allows for representation of greater than 256 characters using 8-bit character widths;
accepting a second textual information in a native character set representation;
converting the first textual information to a corresponding character set; and
comparing the converted first textual information to the second textual information.
